(19) United States
(12) Patent Application Publication
(10) Pub. No.: US 2024/0210178 A1
(43) Pub. Date: Jun. 27, 2024

(54) MAP GENERATION/SELF-POSITION ESTIMATION DEVICE

(71) Applicant: HITACHI ASTEMO, LTD., Hitachinaka-shi, Ibaraki (JP)

(72) Inventors: Hideyuki KUME, Chiyoda-ku, Tokyo (JP); Morihiko SAKANO, Chiyoda-ku, Tokyo (JP); Takehito OGATA, Chiyoda-ku, Tokyo (JP); Yuichi KOMORIYA, Hitachinaka-shi, Ibaraki (JP); Hidehiro TOYODA, Hitachinaka-shi, Ibaraki (JP)

(73) Assignee: HITACHI ASTEMO, LTD., Hitachinaka-shi, Ibaraki (JP)

(21) Appl. No.: 18/557,351

(22) PCT Filed: Feb. 17, 2022
(86) PCT No.: PCT/JP2022/006468

§ 371 Date: Oct. 26, 2023

(30) Foreign Application Priority Data
May 13, 2021 (JP) 2021-081705

(51) Int. Cl. G01C 21/30; B60W 50/08; G01C 21/00; G06V 20/56

(52) U.S. Cl. CPC G01C 21/30; B60W 50/082; G01C 21/3837; G06V 20/56

(57) ABSTRACT

An object is to provide a map generation/self-position estimation device that can estimate the accuracy of self-position estimation using a generation map at the time of map generation without prior learning movement, installation of a known object in an environment, and addition of a sensor. Included are a data allocation unit 110 that allocates an output of a sensor to map data 210 and position estimation data 220 and calculates a true value of a relative position between data of the map data 210 and the position estimation data 220 based on a data allocation method, a map generation unit 120 that generates a generation map including a point group and a travel position of the own vehicle from the map data 210, a self-position estimation unit 130 that estimates a position attitude of the own vehicle on the generation map by associating the position estimation data 220 with the generation map, and an accuracy evaluation unit 140 that evaluates accuracy of the position attitude of the own vehicle on the generation map estimated by the self-position estimation unit 130 from the true value of the relative position between the data.

### TECHNICAL FIELD

The present invention relates to a map generation/self-position estimation device.

### BACKGROUND ART

In order to expand the application range of the automatic driving/driving assistance system, it is important to acquire information from a map based on self-position estimation. However, maps for automatic driving/driving assistance system are organized regarding expressways, but those regarding general roads and residential areas such as neighborhood of someone's house have not been organized. On the other hand, there is a method of self-generating a map including data on surrounding objects and a travel route at the time of the first travel and estimating the position attitude of the own vehicle on a generation map at the time of the next or subsequent travel, but there is a problem that an error of self-position estimation increases depending on the generated map, and the method cannot be used for an automatic driving/driving assistance system. On the other hand, PTL 1 describes that “A self-position estimation device includes a first self-position estimation part, a second self-position estimation part, an abnormality occurrence probability calculation expression storage part, an abnormality occurrence probability calculation part, and a final self-position estimation part. The first self-position estimation part updates the probability distribution of the state of a mobile body to the latest state by using at least an environmental map of the movement area and “the distance from the mobile body to an object existing in the movement area” and “the orientation of the object with respect to the mobile body” observed in a current step, and estimates a first self-position based on the probability distribution of the latest state. The second self-position estimation part estimates a second self-position by adding a movement distance and the movement direction of the mobile body from a previous step to a current step acquired by the odometry to the final self-position of the mobile body in a previous step estimated by the final self-position estimation part. The abnormality occurrence probability calculation expression storage part stores an abnormality occurrence probability calculation expression obtained by machine learning of learning data acquired when the first self-position estimation part estimates the first self-position at the time of learning movement of the mobile body. The abnormality occurrence probability calculation part calculates an abnormality occurrence probability by inputting a plurality of variables acquired when the first self-position estimation part estimates the first self-position to the abnormality occurrence probability calculation expression at the time of main movement of the moving body. The final self-position estimation part obtains, as the final self-position in the current step, a weighted mean value calculated by using the first self-position acquired from the first self-position estimation part and the second self-position acquired from the second self-position estimation part. The learning data includes a plurality of pieces of data in which the plurality of variables acquired when the first self-position estimation unit estimates the first self-position at the time of the learning movement and a classification result when the first self-position estimation result at that time is classified as normal or abnormal are associated with each other. A weighing factor to be used by the final self-position estimation part is a function of the abnormality occurrence probability acquired by the abnormality occurrence probability calculation part.”

### CITATION LIST

### Patent Literature

PTL 1: JP 6438354 B2

### SUMMARY OF INVENTION

### Technical Problem

The invention described in PTL 1 can calculate an abnormality occurrence probability of self-position estimation by machine learning using learning data acquired at the time of prior learning movement. However, there is a problem that prior learning movement is necessary in application to an automatic driving/driving assistance system based on map generation/self-position estimation. There is a problem that installation of a known object to the environment or addition of a sensor is necessary in order to acquire a true value of self-position estimation at the time of learning movement. In addition, there is a problem that the abnormality occurrence probability is calculated at the time of self-position estimation. It is desired to determine abnormality and stop the system as little as operation of the automatic possible during the driving/driving assistance system based on self-position estimation. On the other hand, in map generation/self-position estimation, the generated map greatly affects the self-position estimation accuracy. Therefore, it is necessary to estimate the accuracy of self-position estimation using the generation map at the time of map generation that is the first travel.

The present invention has been made in view of the above circumstances, and an object is to provide a map generation/self-position estimation device that can estimate the accuracy of self-position estimation using a generation map at the time of map generation without prior learning movement, installation of a known object in an environment, and addition of a sensor.

### Solution to Problem

One of representative map generation/self-position estimation devices of the present invention includes: a data allocation unit that allocates data acquired by an external sensor that measures an environment around an own vehicle to map generation data and self-position estimation data; a map generation unit that generates a map based on the map generation data; and a self-position estimation unit that estimates a travel position of the own vehicle on the generation map based on the generation map generated by the map generation unit and the self-position estimation data, in which the data allocation unit calculates a true value of a relative position between the map generation data and the self-position estimation data based on a data allocation method, and the map generation/self-position estimation device includes an accuracy evaluation unit that evaluates an error in self-position estimation from the true value of the relative position and a self-position estimation result calculated by the self-position estimation unit.

### Advantageous Effects of Invention

According to the present invention, it is possible to achieve a map generation/self-position estimation device that can estimate the accuracy of self-position estimation using a generation map at the time of map generation without prior learning movement, installation of a known object in an environment, and addition of a sensor.

Problems, configurations, and effects other than those described above will be made clear by the description of the following embodiments.

### BRIEF DESCRIPTION OF DRAWINGS

FIG. 1 is a view illustrating a block configuration of a map generation/self-position estimation device 100 of a first embodiment.

FIG. 2 is a view showing an example of a true value 230 of a relative position between data.

FIG. 3 is a view showing a flow of data allocation processing for each measurement cycle of an external sensor 310.

FIG. 4 is a view illustrating an example of the true value 230 of a relative position between data in data allocation for each measurement cycle of the external sensor 310.

FIG. 5 is a view illustrating an example of data allocation in a case where a stereo camera 350 is used as the external sensor 310.

FIG. 6 is a view illustrating an example of an environment in which a vehicle has traveled.

FIG. 7 is a view illustrating an example of a generation map 240 generated by a map generation unit 120.

FIG. 8 is a view illustrating an example of a position attitude 252 of an own vehicle estimated by a self-position estimation unit 130.

FIG. 9 is a view illustrating an example of accuracy evaluation in an accuracy evaluation unit 140.

FIG. 10 is a view illustrating a block configuration of a map generation/self-position estimation device 500 of a second embodiment.

FIG. 11 is a view illustrating a block configuration of a map generation/self-position estimation device 600 of a third embodiment.

### DESCRIPTION OF EMBODIMENTS

Hereinafter, embodiments of the present invention will be described with reference to the drawings. Note that in all the drawings for describing the embodiments of the invention, parts having the same functions are denoted by the same reference signs, and repeated description thereof may be omitted.

### First Embodiment

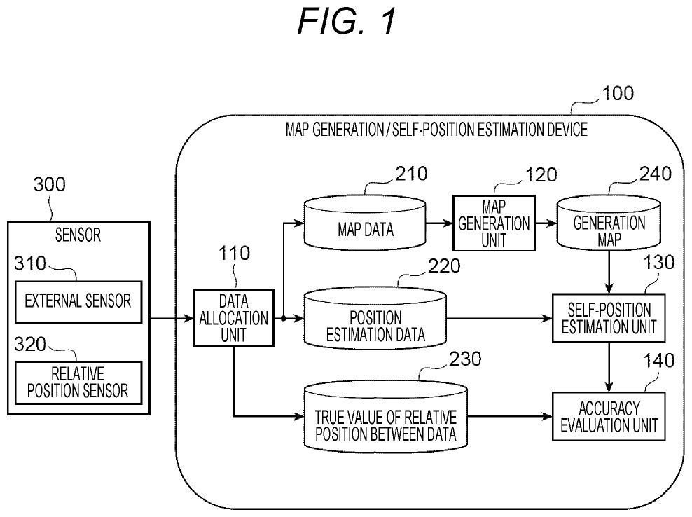

Hereinafter, the first embodiment of the map generation/self-position estimation device will be described with reference to FIGS. 1 to 9. Note that the map generation/self-position estimation device is configured as a computer including a processor such as a central processing unit (CPU), a memory such as a read only memory (ROM), a random access memory (RAM), and a hard disk drive (HDD). Each function of the map generation/self-position estimation device is implemented by a processor executing a program stored in a ROM. The RAM stores data including intermediate data of calculation by a program executed by the processor.

### (Block Configuration)

FIG. 1 is a view illustrating a block configuration of the map generation/self-position estimation device 100 of the first embodiment. To the map generation/self-position estimation device 100, measurement data of a sensor group 300 (hereinafter, sometimes simply referred to as sensor 300) is input. The map generation/self-position estimation device 100 includes a data allocation unit 110, the map generation unit 120, the self-position estimation unit 130, and the accuracy evaluation unit 140.

The map generation/self-position estimation device 100 generates and saves, as a generation map, a map including a point group (a set of points obtained as a measurement result of objects around the own vehicle) and a travel position of the own vehicle from the output of the sensor 300.

The data allocation unit 110 allocates the output of the sensor 300 to map data (also referred to as map generation data) 210 and position estimation data (also referred to as self-position estimation data) 220. The data allocation unit 110 calculates the true value 230 of the relative position between data of map data 210 and position estimation data 220 based on the data allocation method. The map generation unit 120 generates the generation map 240 including the point group and the travel position of the own vehicle from the map data 210. By associating the position estimation data 220 with the generation map 240, the self-position estimation unit 130 estimates the position attitude of the own vehicle on the generation map. The accuracy evaluation unit 140 evaluates the accuracy of the position attitude of the own vehicle on the generation map estimated by the self-position estimation unit 130 from the true value 230 of the relative position between the data.

### (Sensor Configuration)

The configuration of the sensor 300 that inputs measurement data to the map generation/self-position estimation device 100 will be described. The sensor 300 includes a plurality of sensors (310 and 320) having different characteristics.

The external sensor 310 is a sensor that is mounted on a vehicle (own car or own vehicle) and measures the environment around the vehicle. The external sensor 310 is, for example, a monocular camera, a stereo camera, LiDAR, a millimeter wave radar, sonar, or the like, and measures a three-dimensional position of an object existing around the vehicle. Note that in a case where a monocular camera is used, the data to be acquired is an image, and the three-dimensional position cannot be directly acquired, but the three-dimensional position can be measured by using a plurality of images by a known motion stereo method or the like. The three-dimensional position of a white line, a stop line, a crosswalk, and the like detected in the image may be estimated by assuming the shape of a road surface. Measurement results (external recognition data) of an arbitrary number of one or more external sensors are input to the map generation/self-position estimation device 100.

A relative position sensor 320 is a sensor that outputs a relative position of the own vehicle. However, similarly to the external sensor 310, processing of estimating the relative position of the own vehicle from the measurement result of the sensor is included. Here, the relative position represents a position attitude with reference to a position attitude of the vehicle at a certain time. For example, the relative position sensor 320 may use a known wheel odometry method for estimating a relative motion of the own vehicle from a steering angle and a rotation amount of the tire of the vehicle. The relative position sensor 320 may use a known image odometry method or a LiDAR odometry method for estimating a relative motion of the own vehicle from the measurement result of the camera or the LiDAR, which is the external sensor 310.

Note that whereabouts in the vehicle to set the reference of the position attitude of the vehicle is arbitrary. In the present example, the reference of the position attitude of the vehicle is the position attitude of the external sensor 310. That is, the position attitude of the vehicle and the position attitude of the external sensor 310 are the same. Even in a case where another place of the vehicle is used as a reference, by using the attachment position attitude of the external sensor 310 with respect to the reference position attitude of the vehicle acquired by prior calibration, it is possible to convert the position attitude of the external sensor 310 into the position attitude of the vehicle at an arbitrary timing of processing. Therefore, wherever the reference of the position attitude of the vehicle is set, the present invention can be applied by appropriately changing the position attitude.

In a case where a plurality of external sensors 310 exist, the position attitude of an arbitrary one of the external sensors 310 is used as the reference of the position attitude of the vehicle. By using of the position attitude between the plurality of external sensors 310 acquired by the prior calibration, it is possible to convert the position attitude of the external sensor 310 as the reference into the position attitude of another external sensor 310 at an arbitrary timing of processing.

### (Operation of Map Generation/Self-Position Estimation Device)

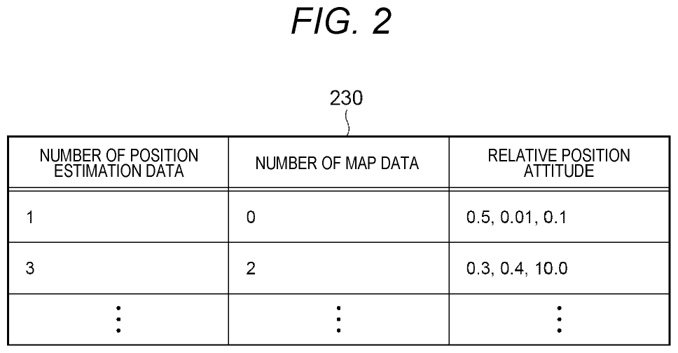

The content of processing in each unit of the map generation/self-position estimation device 100 to which measurement data of the sensor 300 is input will be described with reference to FIGS. 2 to 9.

### (Operation of Data Allocation Unit)

First, the content of processing in the data allocation unit 110 will be described with reference to FIGS. 2 to 5. The data allocation unit 110 allocates the output of the sensor 300 to the map data 210 and the position estimation data 220. The data allocation unit 110 calculates the true value 230 of the relative position between data of map data 210 and position estimation data 220 based on the data allocation method.

FIG. 2 is a view showing an example of the true value 230 of a relative position between data. The true value 230 of the relative position between the data is defined by a set of the number of the position estimation data 220, the number of the map data 210, and the relative position attitude. The number of the position estimation data 220 and the number of the map data 210 are numbers set for each measurement cycle of the external sensor 310. That is, each piece of the position estimation data 220 is associated with a certain piece of the map data 210. The relative position attitude is a relative position attitude between the position attitude of the own vehicle at the time of acquisition of the map data 210 and the position attitude of the own vehicle at the time of acquisition of the position estimation data 220. Note that in a case where a plurality of external sensors 310 exist, the data number is given so that it is possible to distinguish which external sensor 310 to have acquired the data. For example, a data number of x-y is given to the y-th data acquired by the x-th external sensor 310.

The true value 230 of the relative position between the data is calculated based on a data allocation method. A specific calculation method will be described later.

Various methods are conceivable as a data allocation method by the data allocation unit 110. Hereinafter, a data allocation method for each measurement cycle of the external sensors 310, a data allocation method for each external sensor in a case where a plurality of external sensors 310 exist, and a data allocation method based on the data capacity of the generation map 240 will be described. However, the data allocation method is not limited to this. A plurality of data allocation methods may be used in combination.

Note that the data allocation unit 110 desirably exclusively allocates the output of the sensor 300 to the map data 210 and the position estimation data 220. This is because the more the map generation unit 120 and the self-position estimation unit 130 use the same data, the more the accuracy of estimation by the accuracy evaluation unit 140 is improved than the accuracy of the self-position estimation at the time of the next travel that is desired to estimate originally.

### (Data Allocation for Each Measurement Cycle of External Sensor)

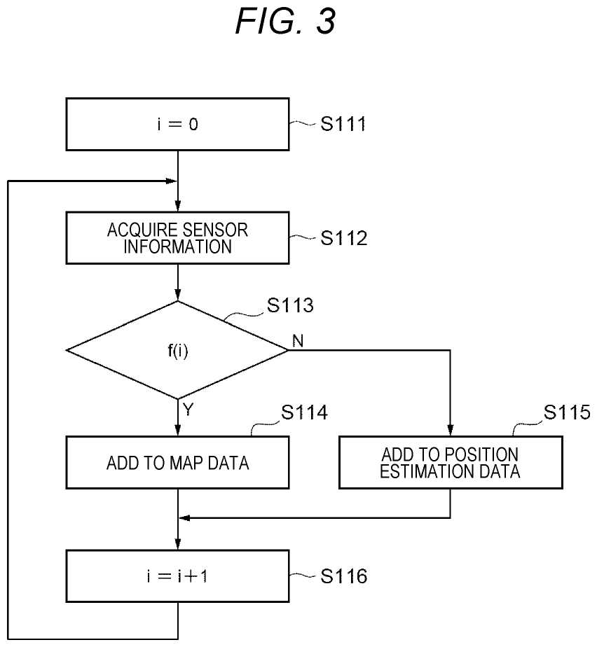

FIG. 3 is a view showing a flow of data allocation processing for each measurement cycle of the external sensor 310. In step S111, the number of times i of measurement of the external sensor 310 is initialized with 0, and the process proceeds to step S112. In step S112, information is acquired from the sensor 300, and the process proceeds to step S113. Note that when the measurement cycles of the external sensor 310 and the relative position sensor 320 do not coincide with each other, interpolation processing or the like is applied to the data of the relative position sensor 320 to acquire the position attitude of the own vehicle at the measurement timing of the external sensor 310. In step S113, the process proceeds to step S114 when a function f(i) is true, and the process proceeds to step S115 when the function f(i) is false. In step S114, the data of the sensor 300 of the number of times i of measurement is added to the map data 210, and the process proceeds to step S116. In step S115, the data of the sensor 300 of the number of times i of measurement is added to the position estimation data 220, and the process proceeds to step S116. In step S116, the number of times i of measurement is incremented by 1, and the process proceeds to step S112.

Here, the function f(i) is an arbitrary function that takes the number of times i of measurement of the sensor 300 as an input and returns a true/false value. For example, by setting the function f(i) to a function that returns true when i is an even number and returns false when i is an odd number, it is possible to alternately add data to the map data 210 and the position estimation data 220 for each measurement by the sensor 300. The function f(i) may be a function that randomly returns true/false regardless of the number of times i of measurement.

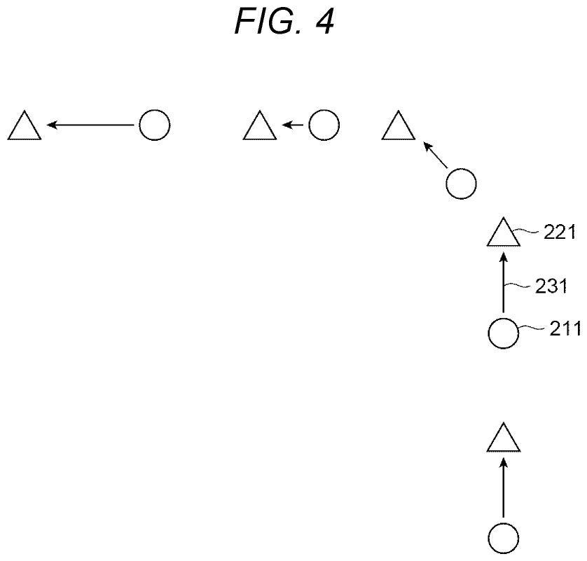

FIG. 4 is a view illustrating an example of the true value 230 of a relative position between data in data allocation for each measurement cycle of the external sensor 310. FIG. 4 illustrates a position attitude 211 of the own vehicle when the data allocated to the map data 210 is acquired, a position attitude 221 of the own vehicle when the data allocated to the position estimation data 220 is acquired, and a relative position attitude 231 included in the true value 230 of the relative position between the data. FIG. 4 illustrates an example of a case where data is alternately allocated to the map data 210 and the position estimation data 220 by setting the function f(i) to a function that returns true when i is an even number and returns false when i is an odd number.

As mentioned earlier, the true value 230 of the relative position between the data is defined by a set of the number of the position estimation data 220, the number of the map data 210, and the relative position attitude 231. For example, in the data allocation for each measurement cycle of the external sensor 310, the map data 210 corresponding to each position estimation data 220 is set as the number of the newest map data 210 at the time of addition of each position estimation data 220. The relative position attitude 231 is a relative position attitude from the position attitude of the own vehicle at the time of acquisition of the map data 210 corresponding to each position estimation data 220 to the position attitude of the own vehicle at the time of acquisition of each position estimation data 220, and is acquired by the relative position sensor 320. Note that the relative position attitude 231 acquired by the relative position sensor 320 includes an error, but the error in a short distance and a short time is small, and therefore in the present example, the relative position attitude 231 acquired by the relative position sensor 320 is a true value.

The method of obtaining the map data 210 corresponding to each position estimation data 220 is not limited to the above-described method. For example, the map data 210 having the smallest relative position attitude 231 (i.e., spatially closest) may be selected as the corresponding map data 210. In this case, the corresponding map data 210 cannot be determined the time of addition of each position estimation data 220, but the relative position attitude 231 acquired by the relative position sensor 320 becomes a short distance and a short time, and therefore the accuracy of the true value is improved.

### (Data Allocation for Each Sensor)

The data allocation unit 110 may allocate data to each external sensor in a case where a plurality of external sensors 310 exist.

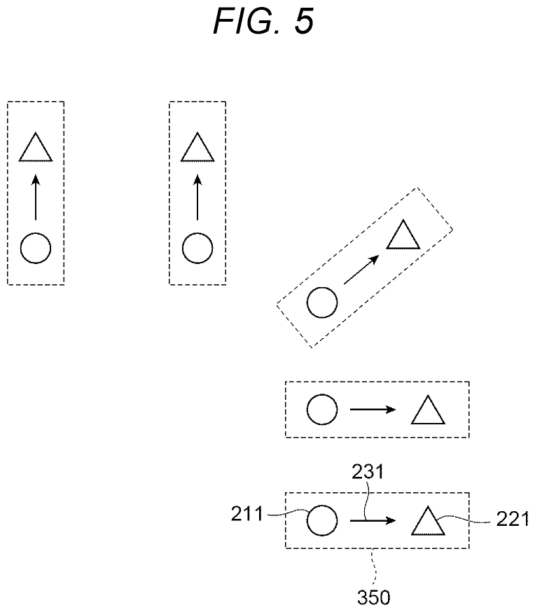

FIG. 5 is a view illustrating an example of data allocation in a case where the stereo camera 350 is used as the external sensor 310. The stereo camera 350 includes a left camera and a right camera. For example, the data allocation unit 110 sets the data acquired by the left camera as the map data 210 and sets the data acquired by the right camera as the position estimation data 220. Note that normally, a stereo camera calculates a distance by associating left and right images, but here, the stereo camera is treated as two monocular cameras with known relative position attitude between sensors. Which camera to allocate to which data may be changed for each measurement cycle.

FIG. 5 illustrates the position attitude 211 of the own vehicle when the data allocated to the map data 210 is acquired, the position attitude 221 of the own vehicle when the data allocated to the position estimation data 220 is acquired, and the relative position attitude 231 included in the true value 230 of the relative position between the data. Here, the position attitude 211 of the own vehicle when the data allocated to the map data 210 is acquired is the position attitude of the left camera, and the position attitude 221 of the own vehicle when the data allocated to the position estimation data 220 is acquired is the position attitude of the right camera. The map data 210 corresponding to each position estimation data 220 is data acquired at the same time. Therefore, the relative position attitude 231 becomes the relative position attitude between the left camera and the right camera, which is calculated by prior calibration in the stereo camera 350.

The external sensor 310 used for data allocation for each sensor is not limited to the stereo camera 350, and can be applied to a plurality of arbitrary external sensors 310. For example, a periphery monitoring camera including four cameras of a front camera, a rear camera, a left camera, and a right camera may be used as the external sensor 310, data acquired by the front camera and the left camera may be the map data 210, and data acquired by the rear camera and the right camera may be the position estimation data 220. Also in this case, when the map data 210 corresponding to each position estimation data 220 is data acquired at the same time, the relative position attitude 231 becomes the position attitude between the cameras calculated by prior calibration.

Note that the external sensor 310 is not limited to a sensor including a plurality of sensors of the same type such as the stereo camera 350 and the periphery monitoring camera, and a similar data allocation method can also be applied to a case of using a plurality of different sensors such as a camera and a LiDAR.

In a case where the measurement timings of the plurality of external sensors 310 do not match, the processing of data allocation for each measurement cycle of the external sensors 310 may be combined. That is, with the newest map data 210 at the time of addition of the position estimation data 220 as the corresponding data, the relative position attitude 231 is calculated from the relative position attitude acquired by the relative position sensor 320 and the relative position attitude between the sensors calculated by the prior calibration.

However, the relative position attitude acquired by the relative position sensor 320 includes an error. Therefore, the data allocation unit 110 may use, for calculation of the true value 230 of the relative position between the data, only the map data 210 and the position estimation data 220 acquired when the own vehicle is stopped. Use of only the data when the own vehicle is stopped can eliminate the influence of a difference in the measurement cycles of the external sensor 310.

In the data allocation for each sensor, when the data allocation method to the external sensors 310 is determined (fixedly) regardless of the number of times of measurement of the external sensors 310, due to a difference in the installation positions of the external sensors 310, it is possible to evaluate an error due to a difference in the travel positions of the generation map 240 and the position estimation data 220. For example, when the left camera of the stereo camera 350 is allocated to the map data 210 and the right camera is allocated to the position estimation data 220, position estimation and accuracy evaluation are performed on the generation map 240 using the data of travel on the right side by the base length of the stereo camera 350. That is, it is possible to estimate the influence of a difference in travel route between the time of first time of map generation and the next and subsequent times of self-position estimation, which causes an error in map generation/self-position estimation.

On the other hand, when the allocation of data to the external sensors 310 is changed (variably) depending on the number of times of measurement of the external sensors 310 (e.g., when the allocation in which the left camera is for the map data 210 and the right camera is for the position estimation data 220 and the allocation in which the left camera is for the position estimation data 220 and the right camera is for the map data 210 are performed in each measurement cycle, in other words, when the camera allocated to the map data 210 and the camera allocated to the position estimation data 220 are alternately changed in each measurement cycle), the generation map 240 is generated using the data of the external sensors 310 having different position attitudes, and therefore it is possible to generate the generation map 240 with less decrease in accuracy due to a difference in travel route at the time of the next or subsequent travel.

### (Data Allocation Based on Data Capacity of Generation Map)

The data allocation unit 110 may allocate data based on the data capacity of the generation map 240.

For example, from the processing of the map generation unit 120 and the performance of the hardware on which the map generation/self-position estimation device 100 is mounted, it is possible to determine the maximum data capacity that can be processed by the map generation unit 120 in the operation at a predetermined processing cycle set in advance. The data capacity required by the map generation unit 120 can be determined based on the performance of the hardware on which the map generation/self-position estimation device 100 is mounted, the specifications of the system, and the maximum capacity of the generation map 240 determined from the capacity of the generation map 240 for the self-position estimation processing to operate in a predetermined processing cycle at the time of the next travel.

Therefore, the data allocation unit 110 may allocate, to the map data 210, the maximum data capacity that can be processed by the map generation unit 120 or (the data of) the data capacity required by the map generation unit 120, and may allocate the remaining data to the position estimation data 220. By allocating data sufficient for generation of the generation map 240 by allocating data in this manner, it is possible to estimate the accuracy of the self-position estimation using the generation map 240 by using data that is not scheduled to be used without deteriorating the generation map 240.

Here, the amount of data acquired from the external sensor 310 varies depending on the surrounding environment, the travel environment, and the like. Therefore, the ratio of data that the data allocation unit 110 allocates to the map data 210 and the position estimation data 220 varies depending on the environment.

Note that depending on the processing of the map generation unit 120, there is a case where the map generation unit 120 determines data to be used for the generation map 240 and data not to be used for the generation map 240. In such a case, the processing of the map generation unit 120 may be performed once using all the data as the map data 210, and data that has not been used in the map generation unit 120 may be used as the position estimation data 220.

### (Operation of Map Generation Unit)

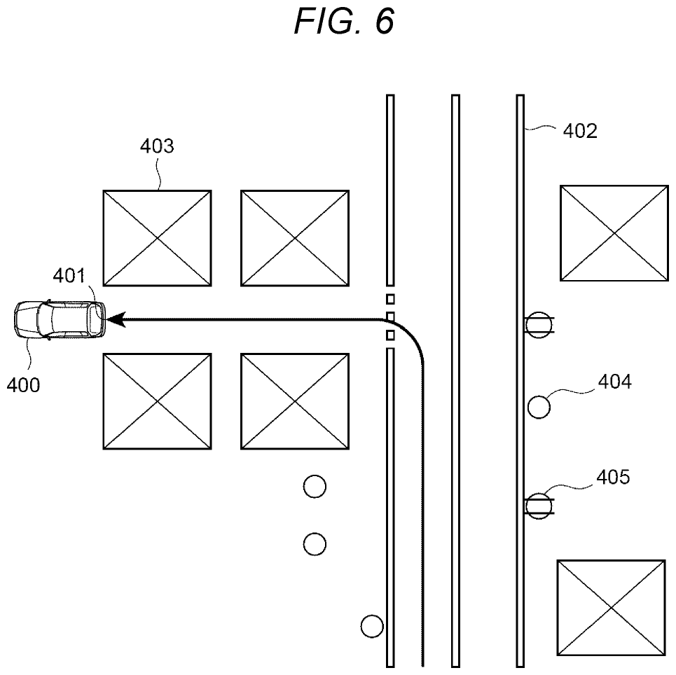

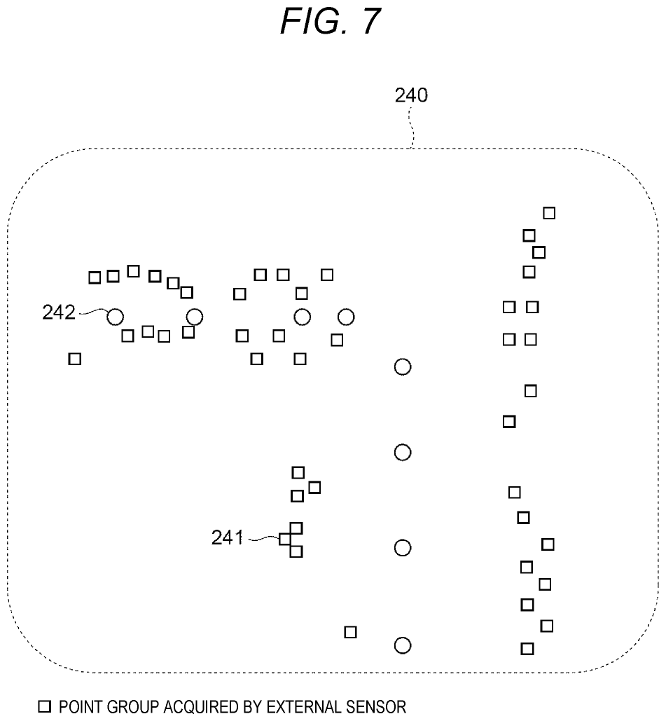

Next, the content of processing in the map generation unit 120 will be described with reference to FIGS. 6 and 7. The map generation unit 120 generates the generation map 240 including the point group and the travel position of the own vehicle from the map data 210. Note that as mentioned earlier, in the present example, the travel position of the own vehicle is the position attitude of the external sensor 310.

FIG. 6 is a view illustrating an example of the environment in which the vehicle has traveled. A vehicle 400 travels along a travel position (travel route) 401, and objects such as lane division lines 402, buildings 403, trees 404, and electric poles 405 exist around the travel position 401.

FIG. 7 is a view illustrating an example of the generation map 240 generated by the map generation unit 120. FIG. 7 illustrates the generation map 240 generated by the map generation unit 120 in the environment illustrated in FIG. 6. The generation map 240 includes a point group 241 acquired by the external sensor 310 and a travel position 242 acquired by the relative position sensor 320.

The point group 241 is a set of points obtained as a result of detecting (measuring) objects around the own vehicle by the external sensor 310 during travel of the vehicle 400.

The travel position 242 is a position attitude of the vehicle 400 at each time acquired by the relative position sensor 320 with the position attitude of the vehicle 400 at a certain time as the origin of a coordinate system.

The point group 241 acquired by the external sensor 310 is acquired by converting the three-dimensional position of the object with reference to the external sensor 310 into the same coordinate system as the travel position 242 by using the travel position 242 at the time when the external sensor 310 measures the point group. That is, the point group 241 and the travel position 242 are positions and position attitudes in the same coordinate system.

The point group 241 and the travel position 242 may be a position and a position attitude in a three-dimensional space, or may be a position and a position attitude in a two-dimensional space. When the three-dimensional space is used, a height and a pitch that are not expressed in the two-dimensional space can be estimated. On the other hand, when the two-dimensional space is used, the data capacity of the generation map 240 can be reduced.

Note that the map generation unit 120 may generate the generation map 240 by adding data for association used by the self-position estimation unit 130 to the point group 241. For example, in a case where a camera is used as the external sensor 310, a feature used for image association may be added to each point of the point group 241. In this case, a known structure from motion (SfM) method or a visual simultaneous localization and mapping (SLAM) method for estimating, from the image, the point group and the position attitude of the camera at the time of capturing the image may be used to acquire the point group 241 and the travel position 242. By using the SfM method or the visual SLAM method, it is possible to leave only points that can be easily associated by the feature.

In a case where the point group 241 is acquired by performing recognition processing of landmarks such as road markings, signals, and signs on the data acquired by the external sensor 310, a result of the recognition processing may be added to each point. For example, in a case where a camera is used as the external sensor 310 and the positions of the road markings or the signs recognized from the image is used as a point group, the type of the road markings or the type of the signs may be saved together. Furthermore, for an object that is preferably stored as not a point such as a white line but a line, parameters of the line may be saved as the generation map 240.

### (Operation of Self-Position Estimation Unit)

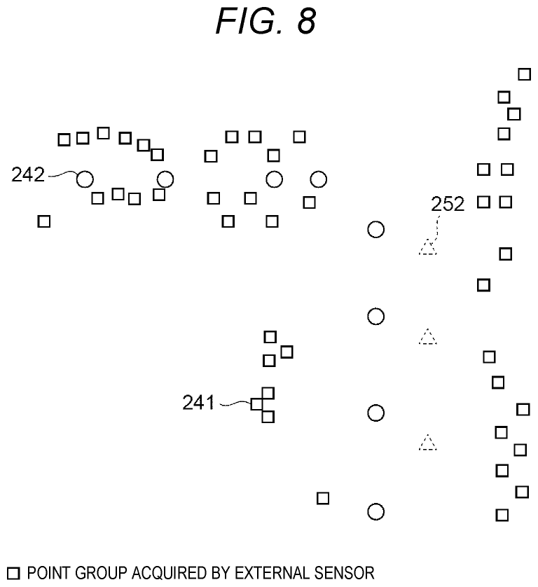

Next, the content of processing in the self-position estimation unit 130 will be described with reference to FIG. 8. By associating the position estimation data 220 with the generation map 240, the self-position estimation unit 130 estimates the position attitude of the vehicle on the generation map.

FIG. 8 is a view illustrating an example of the position attitude 252 of the own vehicle estimated by the self-position estimation unit 130. In FIG. 8, the point group 241 and the travel position 242 represent data of the generation map 240. The self-position estimation unit 130 estimates the position attitude 252 of the own vehicle on these generation maps.

The self-position estimation unit 130 may use a known iterative closest point (ICP) method or normal distributions transform (NDT) method for associating the position estimation data 220 with the generation map 240. In the case of using the ICP method or the NDT method, first, the self-position estimation unit 130 generates a map (current map) including a point group and travel positions by using the same processing as the map generation unit 120 for the position estimation data 220. Next, the self-position estimation unit 130 obtains the position attitude between the generation map 240 and the current map by associating the point groups 241 included in each map by the ICP method or the NDT method. Use of the position attitude between the generation map 240 and the current map enables the position attitude on the map to be converted into the position attitude on the other map. Therefore, by converting the travel position 242 included in the current map into the position attitude on the generation map by using the position attitude between the generation map 240 and the current map, it is possible to obtain the position attitude 252 of the own vehicle on the generation map.

In a case where data for association is saved in the generation map 240, the self-position estimation unit 130 may perform association using the data. For example, in a case where the feature of the image is given to the point group 241 of the generation map 240, the feature point of the image included in the position estimation data 220 and the point group 241 included in the generation map 240 may be associated with each other based on the feature of the image. In this case, the position attitude 252 of the vehicle on the generation map can be obtained by using a known perspective-n-point (PnP) problem solution from the position of the feature point in the image and the position of the point group 241.

In a case where the recognition result of the landmark is saved in the generation map 240, the self-position estimation unit 130 may estimate the position attitude 252 of the vehicle using a known landmark matching method.

### (Operation of Accuracy Evaluation Unit)

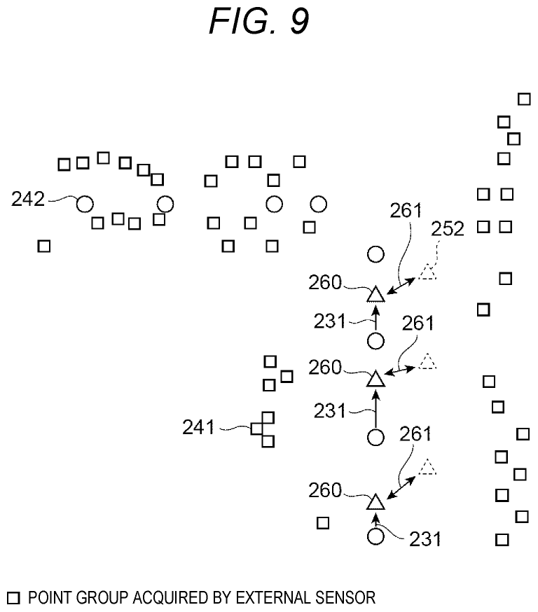

Next, the content of processing in the accuracy evaluation unit 140 will be described with reference to FIG. 9. The accuracy evaluation unit 140 evaluates the accuracy of the position attitude 252 of the vehicle on the generation map estimated by the self-position estimation unit 130 from the true value 230 of the relative position between the data.

FIG. 9 is a view illustrating an example of accuracy evaluation in the accuracy evaluation unit 140. By referring to the true value 230 of the relative position between the data with respect to the position attitude 252 of each own vehicle estimated by the self-position estimation unit 130, the accuracy evaluation unit 140 acquires the number and the relative position attitude 231 of the corresponding map data 210 (see FIG. 2 and the like). Next, a true position attitude (travel position) 260 on the generation map is calculated from the position attitude (travel position) 242 on the generation map 240 of the corresponding map data 210 and the relative position attitude 231. Finally, a difference between the true position attitude 260 and the position attitude 252 estimated by the self-position estimation unit 130 is calculated as an error 261.

Here, the accuracy evaluation unit 140 can evaluate the self-position estimation accuracy using the generation map 240 regardless of the internal processing of the map generation unit 120 and the self-position estimation unit 130. Therefore, although the conditions under which the self-position estimation accuracy decreases are different in accordance with the processing used by the map generation unit 120 and the self-position estimation unit 130, the accuracy of the self-position estimation using the generation map 240 can be uniformly estimated without detecting unique conditions in accordance with the processing.

### (Operation Timing of Map Generation/Self-Position Estimation Device)

Next, the operation timing of the map generation/self-position estimation device 100 will be described. The map generation/self-position estimation device 100 may operate online or may operate offline. That is, the map generation/self-position estimation device 100 may perform processing of each unit for each input from the sensor 300, or may temporarily save all the inputs from the sensor 300 and operate only once using all the saved data when the traveling for map generation ends. In a case where the map generation/self-position estimation device 100 is operated online, a storage area for temporarily saving the input from the sensor 300 is not necessary, but the accuracy of the self-position estimation using the uncompleted generation map 240 is evaluated, and therefore there is a possibility that a difference occurs between the accuracy using the uncompleted generation map 240 and the accuracy in a case where the completed generation map 240 is used. On the other hand, in a case where the map generation/self-position estimation device 100 is operated offline, it is possible to evaluate the accuracy of the self-position estimation using the completed generation map 240, but a storage area for temporarily saving all the inputs from the sensor 300 is required. In the case of being operated offline, the map generation/self-position estimation device 100 can be operated at a timing when other functions are not working such as at the time of parking or stopping and the processing load of the CPU is small.

Here, by combining the online operation and the offline operation, the map generation/self-position estimation device 100 can highly accurately estimate the self-position estimation accuracy using the generation map 240 in a small storage area. Specifically, the data allocation unit 110 and the map generation unit 120 are operated online. Here, the position estimation data 220 allocated by the data allocation unit 110 is saved in the storage area for preset t seconds. Then, the self-position estimation unit 130 performs self-position estimation using the saved position estimation data 220 of t seconds before. By doing this, at the time of each self-position estimation, the generation map 240 includes sections before and after each position estimation data 220. Therefore, the difference in the self-position estimation result can be reduced as compared with the case of using the generation map 240 generated using up to the final data. It is only necessary to temporarily save the position estimation data 220 for t seconds, and it is possible to reduce a necessary storage area as compared with a case of saving all the outputs of the sensor 300. Note that instead of the time (t seconds), the amount of (past) data to be stored by another index such as a travel distance may be determined.

### (Operations and Effects)

According to the first embodiment described above, the following operations and effects can be obtained.

(1) The map generation/self-position estimation device 100 includes a data allocation unit 110, the map generation unit 120, the self-position estimation unit 130, and the accuracy evaluation unit 140. The data allocation unit 110 allocates the output of the sensor 300 to the map data 210 and the position estimation data 220. The data allocation unit 110 calculates the true value 230 of the relative position between data of map data 210 and position estimation data 220 based on the data allocation method (of the output of the sensor 300). The map generation unit 120 generates the generation map 240 including the point group and the travel position of the own vehicle from the map data 210. By associating the position estimation data 220 with the generation map 240, the self-position estimation unit 130 estimates the position attitude (travel position or self-position) of the vehicle on the generation map. The accuracy evaluation unit 140 evaluates the accuracy of the position attitude (travel position or self-position) of the own vehicle on the generation map estimated by the self-position estimation unit 130 from the true value 230 of the relative position between the data (FIG. 1). Therefore, it is possible to estimate the accuracy of the self-position estimation using the generation map 240 at the time of map generation without traveling in advance, installation of a known object, or addition of a sensor. The accuracy of the self-position estimation using the generation map 240 can be estimated regardless of the processing used by the map generation unit 120 and the self-position estimation unit 130. Therefore, although the conditions under which the self-position estimation accuracy decreases are different in accordance with the processing used by the map generation unit 120 and the self-position estimation unit 130, the accuracy of the self-position estimation using the generation map 240 can be uniformly estimated without detecting unique conditions in accordance with the processing.

(2) The data allocation unit 110 allocates the data of the measurement cycle to either the map data 210 or the position estimation data 220 for each measurement cycle of the external sensor 310 (FIG. 3). The data allocation unit 110 calculates the true value 230 of the relative position between the data based on the relative movement amount of the own vehicle acquired by the relative position sensor 320 (FIGS. 2 and 4). Therefore, even in a case where there is one external sensor 310, the accuracy of the self-position estimation using the generation map 240 can be estimated.

(3) When calculating the true value 230 of the relative position between the data, the data allocation unit 110 sets the map data 210 corresponding to each position estimation data 220 as the number of the newest map data 210 at the time of addition of each position estimation data 220 (FIGS. 2 and 4). In other words, when allocating the data acquired by the external sensor 310 to the position estimation data 220, the data allocation unit 110 sets the relative position attitude between the newest map data 210 and the position estimation data 220 as the true value 230 of the relative position between the data. Therefore, at the time of addition of each self-position estimation data 220, the corresponding map data 210 can be determined, and the processing becomes simple.

(4) When calculating the true value 230 of the relative position between the data, the data allocation unit 110 sets the map data 210 corresponding to each position estimation data 220 as the map data 210 having the smallest magnitude of the relative position attitude 231. In other words, the data allocation unit 110 selects the map data 210 having the smallest difference in the relative position attitude with respect to each of the position estimation data 220, and sets the relative position attitude between the position estimation data 220 and the map data 210 as the true value 230 of the relative position between the data. Therefore, the error in the relative position attitude 231 acquired by the relative position sensor 320 is reduced, and the accuracy of the self-position estimation using the generation map 240 can be estimated with high accuracy.

(5) In a case where a plurality of external sensors 310 exist, the data allocation unit 110 allocates data (data measured by each external sensor) to either the map data 210 or the position estimation data 220 for each external sensor. The data allocation unit 110 calculates the true value 230 of the relative position between the data based on the installation position attitude between the external sensors calculated by the prior calibration (FIG. 5). Therefore, in the case where the plurality of external sensors 310 exist, it is possible to estimate the accuracy of the self-position estimation using the generation map 240 by using a highly accurate true value obtained by calibration.

(6) In the case where the plurality of external sensors 310 exist, the data allocation unit 110 fixedly allocates data for each external sensor to either the map data 210 or the position estimation data 220 regardless of the number of times of measurement (measurement cycle) of the external sensors 310 (FIG. 5). Therefore, since the position attitudes of the external sensors 310 that have measured the data of the map data 210 and the position estimation data 220 are different, it is possible to estimate the self-position estimation error due to the difference between the generation map 240 and the travel position at the time of self-position estimation.

(7) In the case where the plurality of external sensors 310 exist, the data allocation unit 110 variably allocates data for each external sensor to either the map data 210 or the position estimation data 220 depending on the number of times of measurement (measurement cycle) of the external sensors 310. Therefore, since the map data 210 includes data measured from the plurality of position attitudes, it is possible to generate the generation map 240 in which an error due to a difference between the generation map 240 and the travel position at the time of self-position estimation hardly occurs.

(8) The data allocation unit 110 uses, for calculation of the true value 230 of the relative position between the data, only the map data 210 and the position estimation data 220 acquired by each external sensor 310 when the own vehicle is stopped. Therefore, it is possible to estimate the accuracy of the self-position estimation using the generation map 240 with the influence of the difference between the measurement cycles of the plurality of external sensors 310 eliminated.

(9) The data allocation unit 110 allocates the data of the external sensor 310 based on the maximum data capacity that can be processed by the map generation unit 120 set in advance or the data capacity required by the map generation unit 120. Therefore, by allocating sufficient data for generation of the generation map 240, it is possible to estimate the accuracy of the self-position estimation using the generation map 240 by using data that is not scheduled to be used without deteriorating the generation map 240.

(10) The data allocation unit 110 exclusively allocates the map data 210 and the position estimation data 220 (FIGS. 3 to 5). Note that the present invention may adopt complete exclusion or needs not adopt complete exclusion, but preferably adopts complete exclusion. Therefore, the accuracy of the self-position estimation using the generation map 240 can be estimated with high accuracy.

(11) The map generation/self-position estimation device 100 operates the data allocation unit 110 and the map generation unit 120 online. The map generation/self-position estimation device 100 temporarily saves the position estimation data 220, and the self-position estimation unit 130 estimates the position attitude (travel position) of the own vehicle on the generation map 240 by using the generation map 240 generated by the map generation unit 120 and the temporarily saved past position estimation data 220. Therefore, since the accuracy is evaluated with respect to the result of the self-position estimation using the generation map 240 generated by the map data 210 before and after each position estimation data 220, the accuracy of the self-position estimation using the generation map 240 can be highly accurately estimated with a small storage area.

### (Modification 1)

In the above-described example, the accuracy evaluation unit 140 calculates a difference between the true position attitude 260 and the position attitude 252 estimated by the self-position estimation unit 130 as the error 261 (FIG. 9). However, the method of accuracy evaluation is not limited to this.

The accuracy evaluation unit 140 may calculate a statistic such as a mean or standard deviation of the errors 261 or a distribution of the errors 261. Therefore, by changing the data allocation method, the data allocation unit 110 may prepare a plurality of sets of the map data 210, the position estimation data 220, and the true value 230 of the relative position between the data.

For example, the data allocation unit 110 prepares a plurality of sets of data having different data allocation methods by using a plurality of different functions f (i) for data of the same sensor 300 in data allocation for each measurement cycle of the external sensor 310. Here, the function f (i) may be a function that randomly returns a value regardless of the number of times i of measurement of the external sensor 310.

The data allocation unit 110 may prepare a plurality of sets of data by changing the external sensors 310 to be allocated to the map data 210 and the position estimation data 220 in the data allocation for each external sensor. For example, in a case of using the stereo camera 350, two sets of data may be prepared by performing allocation in which the left camera is the map data 210 and the right camera is the position estimation data 220 and allocation in which the left camera is the position estimation data 220 and the right camera is the map data 210. In each measurement cycle, which of the left and right cameras to be allocated to which data may be randomly determined.

The map generation unit 120 and the self-position estimation unit 130 perform map generation and self-position estimation processing for each of a plurality of sets of the map data 210 and the position estimation data 220. The accuracy evaluation unit 140 calculates as many errors 261 as the number of sets of data prepared by the data allocation unit 110, and calculates a statistic such as a mean or standard deviation of the errors 261 or the distribution of the errors 261 from the plurality of errors 261.

According to Modification 1 described above, the following operations and effects can be obtained. That is, by varying the data allocation method of the data of the external sensor 310, the data allocation unit 110 prepares sets of a plurality of pieces of the map data 210, the position estimation data 220, and the true value 230 of the relative position between the pieces of data, and the map generation unit 120 and the self-position estimation unit 130 perform map generation and self-position estimation on the data of each set. That is, the map generation unit 120 generates a generation map for each of the plurality of pieces of map data 210, and the self-position estimation unit 130 estimates the travel position of the own vehicle on each generation map by using the plurality of generation maps and the position estimation data 220 corresponding to the plurality of generation maps. The accuracy evaluation unit 140 calculates a statistic such as a mean or standard deviation of the errors 261 or the distribution of the errors 261 from the error 261 of the self-position estimation result for each set of data. Therefore, it is possible to obtain more advanced accuracy estimation such as the statistic and the distribution of the error 261. In other words, it is possible to robustly estimate the self-position estimation accuracy using the generation map 240.

### (Modification 2)

In the above-described example, the data allocation unit 110 allocates the output of the sensor 300 to the map data 210 and the position estimation data 220. However, the processing of the data allocation unit 110 is not limited to this.

The data allocation unit 110 may give noise to the map data 210 and the position estimation data 220. For example, the data allocation unit 110 gives noise to the position of the point group acquired by the external sensor 310 and the relative position attitude acquired by the relative position sensor 320. In a case where a camera is used as the external sensor 310, noise may be given to an image acquired by the camera. A plurality of sets of data in which the magnitude of noise is varied may be prepared. The accuracy evaluation unit 140 evaluates the accuracy for each set of data.

According to Modification 2 described above, the following operations and effects can be obtained. That is, the data allocation unit 110 gives noise to the map data 210 and the position estimation data 220. The accuracy evaluation unit 140 evaluates the accuracy for each set of data to which noise is given. Therefore, the accuracy evaluation unit 140 can calculate the relationship between the magnitude of the noise and the self-position estimation error using the generation map 240. In other words, the accuracy evaluation unit 140 can evaluate the robustness of the self-position estimation using the generation map 240 against noise. It is conceivable that for example, even with the same position estimation error when noise is not given, an environment in which the error does not increase significantly despite the noise being given and an environment in which the error increases significantly due to the noise being given exist. The accuracy evaluation unit 140 can estimate the magnitude of the influence of such noise. By comparing the accuracy in a case where noise is given only to the map data 210 with the accuracy in a case where noise is given only to the position estimation data 220, the accuracy evaluation unit 140 can determine which of the generation map 240 and the input data for self-position estimation has a greater influence on the accuracy.

### Second Embodiment

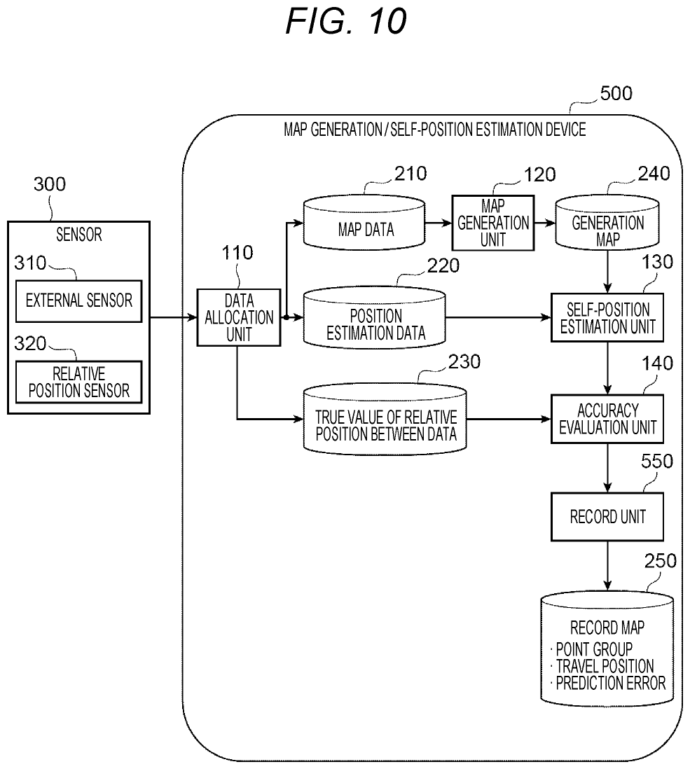

Hereinafter, the second embodiment of the map generation/self-position estimation device will be described with reference to FIG. 10. In the following description, the same components as those of the first embodiment are denoted by the same reference signs, and differences will be mainly described. Points not particularly described are the same as those in the first embodiment. In the present embodiment, in addition to the map generation/self-position estimation device 100 of the first embodiment, a map generation/self-position estimation device including a record unit that records a map based on the error 261 calculated by the accuracy evaluation unit 140 is targeted.

### (Block Configuration)

FIG. 10 is a view illustrating a block configuration of a map generation/self-position estimation device 500 of the second embodiment. The map generation/self-position estimation device 500 includes the data allocation unit 110, the map generation unit 120, the self-position estimation unit 130, the accuracy evaluation unit 140, and a record unit 550. The record unit 550 records a record map 250 based on the error 261 calculated by the accuracy evaluation unit 140.

### (Operation of Record Unit)

The content of processing in the record unit 550 will be described. The record unit 550 records a record map 250 based on the error 261 calculated by the accuracy evaluation unit 140.

For example, the record unit 550 determines whether or not to record the entire generation map 240. In this case, the record unit 550 records the generation map 240 as the record map 250 in a case where the mean or the maximum value of the errors 261 for each position estimation data 220 calculated by the accuracy evaluation unit 140 is less than a preset threshold, and does not record the generation map 240 as the record map 250 in a case where the mean or the maximum value is equal to or greater than the threshold.

In addition to the point group and the travel position included in the generation map 240, the record map 250 may record, as a prediction error, the error 261 calculated by the accuracy evaluation unit 140. Here, since the record map 250 does not include the position estimation data 220, the number of the map data 210 used to calculate the error 261 and the prediction error are recorded together for recording of the prediction error. That is, the prediction error is recorded for each travel position included in the record map 250.

The record unit 550 may record a part of the generation map 240 as the record map 250. For example, in the generation map 240, only a part (section) generated from the map data 210 in which the error 261 calculated by the accuracy evaluation unit 140 becomes less than the preset threshold may be used as the record map 250. The generation map 240 may be divided into a plurality of small maps based on, for example, the travel distance, and the above-described processing may be applied to each divided map to determine whether or not to record. Due to this, when an error in self-position estimation using the generation map 240 is only partially large, only a part (section) with a small error can be recorded as a record map and used at the time of the next travel.

The record unit 550 may notify an HMI unit not illustrated connected to the map generation/self-position estimation device 500 of whether or not to have recorded the record map 250. The HMI unit uses a display or a speaker to notify the driver whether a map has been recorded.

### (Operations and Effects)

According to the second embodiment described above, the following operations and effects can be obtained.

(1) The record unit 550 records the generation map 240 as the record map 250 based on the error 261 calculated by the accuracy evaluation unit 140 (FIG. 10). The record unit 550 records the generation map 240 as the record map 250 (only) in the case where the mean or maximum value of the errors 261 with respect to each position estimation data 220 calculated by the accuracy evaluation unit 140 is less than the preset threshold, and does not record the generation map 240 as the record map 250 in the case where the mean or maximum value is equal to or greater than the threshold. Therefore, in a case where the self-position estimation error using the generation map 240 is assumed to be large, the memory use amount can be reduced by not recording the map. It is possible to prevent an abnormal operation and stop of the automatic driving/driving assistance system due to an increase in an error of self-position estimation using the generation map 240 at the time of the next travel.

(2) The record unit 550 records a part of the generation map 240 as the record map 250 based on the error 261 calculated by the accuracy evaluation unit 140. In other words, the record unit 550 records, as the record map 250, only a part (section) of the generation map 240 where the error 261 in self-position estimation is smaller than a preset threshold. Therefore, when an error in self-position estimation using the generation map 240 is only partially large, only a part with a small error can be recorded as a record map and used at the time of the next travel.

### (Modification 1)

In the above-described example, the record unit 550 determines whether or not to record the entire or a part of the generation map 240 based on the error 261 calculated by the accuracy evaluation unit 140. However, the processing of the record unit 550 is not limited to this.

Similarly to Modification 1 of the first embodiment, by changing the data allocation method, the data allocation unit 110 may prepare a plurality of sets of the map data 210, the position estimation data 220, and the true value 230 of the relative position between the data, and the accuracy evaluation unit 140 may calculate the error 261 for each set of data. In this case, the record unit 550 may record, as the record map 250, the generation map 240 generated in a set having the smallest mean, median, or maximum value of the errors 261 based on the errors 261 of each set.

The map generation unit 120 may generate a plurality of the generation maps 240 from the same map data 210 by varying a parameter (map generation parameter) corresponding to processing used for map generation. The self-position estimation unit 130 performs self-position estimation using each of the generation maps 240 generated by the map generation unit 120, and outputs a self-position estimation result corresponding to the respective generation maps 240. The self-position estimation unit 130 may calculate a plurality of self-position estimation results from the same generation map 240 and the same position estimation data 220 by changing a parameter (self-position estimation parameter) corresponding to processing used for self-position estimation. The accuracy evaluation unit 140 calculates the error 261 using the true value 230 of the relative position between the corresponding data with respect to the plurality of self-position estimation results output by the self-position estimation unit 130. The record unit 550 may record, as the record map 250, the generation map 240 generated in a set having the smallest mean, median, or maximum value of the errors 261. At this time, the record map 250 also records the parameters (map generation parameter and self-position estimation parameter) used respectively by the map generation unit 120 and the self-position estimation unit 130. At the time of the next travel, self-position estimation is performed using the parameters included in the record map 250.

Here, the parameters in the map generation unit 120 and the self-position estimation unit 130 also include selection of the external sensor 310 used for map generation and self-position estimation. That is, in a case where the plurality of external sensors 310 exist, an appropriate sensor that changes corresponding to the environment can be selected based on the error 261 calculated by the accuracy evaluation unit 140.

According to Modification 1 described above, the following operations and effects can be obtained.

(1) That is, by varying the data allocation method of the data of the external sensor 310, the data allocation unit 110 prepares sets of a plurality of pieces of the map data 210, the position estimation data 220, and the true value 230 of the relative position between the pieces of data, and the map generation unit 120, the self-position estimation unit 130, and the accuracy evaluation unit 140 perform map generation, self-position estimation, and accuracy evaluation on the data of each set. That is, the map generation unit 120 generates a generation map for each of the plurality of pieces of map data 210, and the self-position estimation unit 130 estimates the travel position of the own vehicle on each generation map by using the plurality of generation maps and the position estimation data 220 corresponding to the plurality of generation maps. The accuracy evaluation unit 140 calculates the error 261 of self-position estimation on the data of each set. The record unit 550 records, as the record map 250, the generation map 240 generated in the set having the smallest mean, median, or maximum value of the errors 261. Therefore, the generation map 240 that can achieve highly accurate self-position estimation can be recorded as the record map 250.

(2) By varying the parameters, the map generation unit 120 and the self-position estimation unit 130 output the plurality of generation maps 240 and the self-position estimation results, and the accuracy evaluation unit 140 evaluates the accuracy of each self-position estimation result. That is, the map generation unit 120 generates the plurality of generation maps by varying the map generation parameters, the self-position estimation unit 130 calculates the plurality of self-position estimation results by changing the self-position estimation parameters for each of the plurality of generation maps, and the accuracy evaluation unit 140 calculates a plurality of self-position estimation errors. The record unit 550 records, as the record map 250, the generation map 240 generated in the set having the smallest mean, median, or maximum value of the errors 261 and each parameter (map generation parameter and self-position estimation parameter) used by the map generation unit 120 and the self-position estimation unit 130. Therefore, it is possible to highly accurately estimate the position attitude of the own vehicle by performing, at the time of the next travel, self-position estimation using a map generated with a parameter with the small error 261 and a parameter in which an error stored in the map becomes small.

### (Modification 2)

In the above-described example, the record unit 550 records the record map 250 in the map generation/self-position estimation device 500 based on the error 261 calculated by the accuracy evaluation unit 140. However, the processing of the record unit 550 is not limited to this.

The record unit 550 may record the record map 250 in a server not illustrated connected to the map generation/self-position estimation device 500 via a network. That is, the map generated by traveling of the own vehicle may be shared with another vehicle via the server.

In a case where the accuracy of the self-position estimation using the generation map 240 is estimated to be low, the record unit 550 may transmit information on the travel section of the own vehicle to the server instead of the record map 250. Here, the information on the travel section is latitude and longitude, time, and the like acquired by a GNSS. The server can plan map generation using a dedicated measurement vehicle, for example, by collecting information on a section in which the accuracy of the self-position estimation using the generation map 240 is low.

According to Modification 2 described above, the following operations and effects can be obtained.

(1) The record unit 550 records the record map 250 in the server not illustrated connected to e map generation/self-position estimation device 500 via the network. The record unit 550 records the generation map 240 as the record map 250 in a case where the mean or maximum value of the errors 261 with respect to each position estimation data 220 calculated by the accuracy evaluation unit 140 is less than a preset threshold, and does not record the generation map 240 as the record map 250 in a case where the mean or maximum value is equal to or greater than the threshold. Therefore, in a case where the accuracy of the self-position estimation using the generation map 240 is estimated to be low, the record map 250 (generation map 240) is not transmitted to the server, and thus the communication amount can be suppressed. By using a prediction error included in the record map 250, the server can select and distribute a map with which highly accurate self-position estimation is possible from among the record maps 250 received from a plurality of the map generation/self-position estimation devices 500.

(2) When the accuracy of the self-position estimation using the generation map 240 is estimated to be low, the record unit 550 transmits information on the travel section of the own vehicle to the server instead of the record map 250. That is, in a case of not recording the generation map 240 as the record map 250 based on the error in self-position estimation, the record unit 550 transmits information on the travel section of the own vehicle to the server. Therefore, the server can plan map generation using a dedicated measurement vehicle, for example, by collecting information on a section in which the accuracy of the self-position estimation using the generation map 240 is low.

### (Modification 3)

In the above-described example, the map generation/self-position estimation device 500 records the record map 250 based on the error 261 calculated by the accuracy evaluation unit 140 in the record unit 550. However, the operation of the map generation/self-position estimation device 500 is not limited to this.

The map generation/self-position estimation device 500 may further include a sensor abnormality determination unit (not illustrated) that determines an abnormality of the sensor 300 based on the error 261 calculated by the accuracy evaluation unit 140.

For example, in a case where the record map 250 is not recorded continuously for a preset number of times or more, that is, when the accuracy of the self-position estimation using the generation map 240 is determined to be low, the sensor abnormality determination unit may determine that an abnormality has occurred in the sensor 300.

For example, in a case where the plurality of external sensors 310 exist, the map generation/self-position estimation device 500 may perform data allocation for each measurement cycle for each external sensor in the data allocation unit 110, evaluate the accuracy of the self-position estimation using the generation map 240 for each external sensor in the accuracy evaluation unit 140, and determine that the external sensor 310 having the error 261 increased is abnormal in a case where the error 261 is greatly different depending on the external sensor 310.

For example, in a case where three or more external sensors 310 exist, the map generation/self-position estimation device 500 may set the external sensors 310 not to be allocated to either the map data 210 or the position estimation data 220 when the data allocation unit 110 allocates data to each external sensor. The sensor abnormality determination unit may compare accuracy evaluation results for a plurality of sets, and may determine that a specific sensor is abnormal when the accuracy in a case of not using the sensor becomes higher than the accuracy in a case of using the sensor.

According to Modification 3 described above, the following operations and effects can be obtained. That is, the map generation/self-position estimation device 500 further includes the sensor abnormality determination unit that determines an abnormality of the sensor 300 based on the error 261 calculated by the accuracy evaluation unit 140. Therefore, it is possible to determine the abnormality of the external sensor 310.

### Third Embodiment

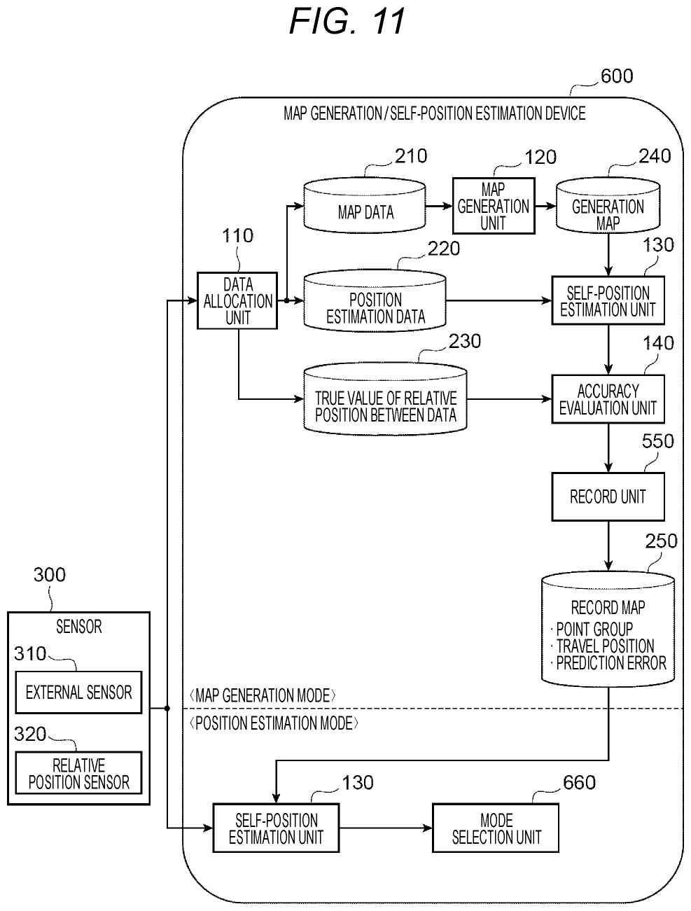

Hereinafter, the third embodiment of the map generation/self-position estimation device will be described with reference to FIG. 11. In the following description, the same components as those of the first embodiment and the second embodiment are denoted by the same reference signs, and differences will be mainly described. Points not particularly described are the same as those in the first embodiment and the second embodiment. The present embodiment targets a map generation/self-position estimation device including, in addition to the map generation/self-position estimation device 500 of the second embodiment, a self-position estimation unit and a mode selection unit that operate when the own vehicle travels again at the same place after recording the record map 250.

### (Block Configuration)

FIG. 11 is a view illustrating a block configuration of a map generation/self-position estimation device 600 of the third embodiment. The map generation/self-position estimation device 600 includes the data allocation unit 110, the map generation unit 120, the self-position estimation unit 130, the accuracy evaluation unit 140, the record unit 550, and a mode selection unit 660. The mode selection unit 660 selects an operation mode of the map generation/self-position estimation device 600 and an operation mode permitted to the automatic driving/driving assistance system connected to the map generation/self-position estimation device 600.

The operation of the map generation/self-position estimation device 600 includes a map generation mode and a position estimation mode. In the map generation mode, a map including a point group (a set of points obtained as measurement results of objects around the own vehicle) and a travel position of the own vehicle is generated from the output of the sensor 300, and is saved as the record map 250. In the position estimation mode, the current position attitude of the own vehicle on the record map 250 is estimated from the output of the sensor 300 and the record map 250.

In the map generation mode, the data allocation unit 110, the map generation unit 120, the self-position estimation unit 130, the accuracy evaluation unit 140, and the record unit 550 operate. The operation in the map generation mode is the same as that of the map generation/self-position estimation device 500 of the second embodiment.

In the position estimation mode, the self-position estimation unit 130 and the mode selection unit 660 operate. The operation of the self-position estimation unit 130 is the same as that in the map generation mode. However, the record map 250 instead of the generation map 240 and the output of the sensor 300 instead of the position estimation data 220 are input to the self-position estimation unit 130.

Note that in the present embodiment, the same (common) self-position estimation unit 130 operates in the map generation mode and the position estimation mode, but a different (other) self-position estimation units 130 different between the map generation mode and the position estimation mode may be prepared and operated.

### (Operation of Mode Selection Unit)

The content of processing in the mode selection unit 660 will be described. The mode selection unit 660 selects an operation mode of the map generation/self-position estimation device 600 and an operation mode permitted to the automatic driving/driving assistance system connected to the map generation/self-position estimation device 600.

First, the mode selection unit 660 obtains a prediction error for an estimation result of the current position attitude from the position attitude of the own vehicle estimated by the self-position estimation unit 130 and the prediction error included in the record map 250. Specifically, the prediction error corresponding to the travel position on the record map 250 closest to the position attitude of the own vehicle estimated by the self-position estimation unit 130 is set as the prediction error of the current position attitude.

The mode selection unit 660 determines the operation mode (map generation mode and position estimation mode) of the map generation/self-position estimation device 600 based on the calculated prediction error of the current position attitude. For example, in a case where the prediction error of the current position attitude is less than a preset threshold, the operation continues as the position estimation mode. On the other hand, in a case where the prediction error of the current position attitude is equal to or greater than the preset threshold, the position estimation mode is switched to the map generation mode. In other words, in a place where the prediction error is large, map generation by the driving of the driver is performed similarly to the first travel instead of operating the automatic driving/driving assistance system using the self-position estimation result.

The mode selection unit 660 selects the operation mode permitted to the automatic driving/driving assistance system connected to the map generation/self-position estimation device 600 based on the calculated prediction error of the current position attitude. For example, as the prediction error of the current position attitude is smaller, the operation at a higher automatic driving level is permitted to the automatic driving/driving assistance system. More specifically, for example, in a case where the prediction error of the current position attitude is smaller than a preset threshold x, the automatic driving/driving assistance system is permitted to perform up to hands-off automatic driving, and in a case where the prediction error of the current position attitude is greater than a preset threshold y (x<y), only an alarm is permitted to the automatic driving/driving assistance system.

### (Operations and Effects)

According to the third embodiment described above, the following operations and effects can be obtained.

(1) The mode selection unit 660 determines the operation mode (map generation mode and position estimation mode) of the map generation/self-position estimation device 600 based on the calculated prediction error of the current position attitude. That is, the record unit 550 includes the error (prediction error) of the self-position estimation calculated by the accuracy evaluation unit 140 into the record map 250, and when the own vehicle travels again in the section where the record map 250 exists, the self-position estimation unit 130 estimates the position attitude of the own vehicle on the record map 250 from the data of the external sensor 310 and the record map 250. The mode selection unit 660 calculates the current prediction error from the position attitude of the own vehicle on the record map 250 estimated by the self-position estimation unit 130 and the error in the self-position estimation included in the record map 250. Then, the mode selection unit 660 selects the operation mode of the map generation/self-position estimation device 600 from the map generation mode and the position estimation mode based on the calculated current prediction error. Therefore, in a place where the prediction error is large, map generation by the driving of the driver can be performed similarly to the first travel instead of operating the automatic driving/driving assistance system using the self-position estimation result.

(2) The mode selection unit 660 selects the operation mode permitted to the automatic driving/driving assistance system connected to the map generation/self-position estimation device 600 based on the calculated prediction error of the current position attitude. Therefore, it is possible to provide the driver with an appropriate automatic driving/driving assistance function in accordance with the accuracy of the self-position estimation.

### SUMMARY

As described above, the map generation/self-position estimation device 100 of the first embodiment described above includes: the data allocation unit 110 that allocates data acquired by an external sensor that measures an environment around an own vehicle to the map generation data 210 and the self-position estimation data 220; the map generation unit 120 that generates a map based on the map generation data 210; and the self-position estimation unit 130 that estimates a travel position of the own vehicle on the generation map based on the generation map generated by the map generation unit 120 and the self-position estimation data 220, in which the data allocation unit 110 calculates a true value of a relative position between the map generation data 210 and the self-position estimation data 220 based on a data allocation method (of data of the external sensor), and the map generation/self-position estimation device 100 includes the accuracy evaluation unit 140 that evaluates an error in self-position estimation (performed by the self-position estimation unit 130) from the true value of the relative position and a self-position estimation result calculated by the self-position estimation unit 130.

In other words, the map generation/self-position estimation device 100 includes the data allocation unit 110 that allocates an output of a sensor to the map data 210 and the position estimation data 220 and calculates a true value of a relative position between data of the map data 210 and the position estimation data 220 based on a data allocation method, the map generation unit 120 that generates a generation map including a point group and a travel position of the own vehicle from the map data 210, the self-position estimation unit 130 that estimates a position attitude of the own vehicle on the generation map by associating the position estimation data 220 with the generation map, and the accuracy evaluation unit 140 that evaluates accuracy of the position attitude of the own vehicle on the generation map estimated by the self-position estimation unit 130 from the true value of the relative position between the data.

The map generation/self-position estimation device 500 of the second embodiment described above further includes the record unit 550 that records the generation map as a record map based on an error in the self-position estimation calculated by the accuracy evaluation unit 140, and the record unit 550 records the generation map as the record map only when the error in the self-position estimation is smaller than the preset threshold. The record unit 550 records, as the record map, only a section of the generation map in which the error in the self-position estimation is smaller than the preset threshold.

In the map generation/self-position estimation device 600 of the third embodiment described above, the record unit 550 includes an error in the self-position estimation calculated by the accuracy evaluation unit 140 into the record map, when the own vehicle travels again in a section where the record map exists, the self-position estimation unit 130 estimates a position attitude of the own vehicle on the record map from data of the external sensor and the record map, and the map generation/self-position estimation device 600 further includes the mode selection unit 660 that calculates the current prediction error from the position attitude of the own vehicle on the record map estimated by the self-position estimation unit 130 and the error in the self-position estimation included in the record map, and selects an operation mode of the map generation/self-position estimation device 600 from the map generation mode and the position estimation mode based on the current prediction error. The mode selection unit 660 selects the operation mode allowed for an automatic driving/driving assistance system connected to the map generation/self-position estimation device 600 based on the current prediction error.

According to the present embodiment described above, it is possible to achieve a map generation/self-position estimation device that can estimate the accuracy of self-position estimation using a generation map at the time of map generation without prior learning movement, installation of a known object in an environment, and addition of a sensor.

Note that the present invention is not limited to the above-described embodiments, and includes various modifications. For example, the above-described embodiments have been described in detail for easy understanding of the present invention, and are not necessarily limited to those having all the described configurations. Other aspects conceivable within the scope of the technical idea of the present invention are also included in the scope of the present invention. It is also possible to replace a part of the configuration E a certain embodiment with the configuration of another embodiment, and it is also possible to add the configuration of another embodiment to the configuration of the certain embodiment. Another configuration can be added to, deleted from, or replaced with a part of the configuration of each embodiment. Some or all of the above-described configurations, functions, processing units, processing means, and the like may be implemented by hardware, for example, by designing with an integrated circuit. Each of the above-described configurations, functions, and the like may be implemented by software by a processor interpreting and executing a program for implementing each function. Information such as a program, a table, and a file that implement each function can be stored in a recording device such as a memory, a hard disk, and a solid state drive (SSD), or a recording medium such as an IC card, an SD card, and a DVD.

### REFERENCE SIGNS LIST

100 map generation/self-position estimation device (first embodiment)
110 data allocation unit
120 map generation unit
130 self-position estimation unit
140 accuracy evaluation unit
210 map data
220 position estimation data
230 true value of relative position between data
240 generation map
250 record map
300 sensor
310 external sensor
320 relative position sensor
500 map generation/self-position estimation device (second embodiment)
550 record unit
600 map generation/self-position estimation device (third embodiment)
660 mode selection unit

1. A map generation/self-position estimation device, comprising:
a data allocation unit that allocates data acquired by an external sensor that measures an environment around an own vehicle to map generation data and self-position estimation data;
a map generation unit that generates a map based on the map generation data; and
a self-position estimation unit that estimates a travel position of the own vehicle on the generation map based on the generation map generated by the map generation unit and the self-position estimation data,
wherein the data allocation unit calculates a true value of a relative position between the map generation data and the self-position estimation data based on a data allocation method, and
the map generation/self-position estimation device includes an accuracy evaluation unit that evaluates an error in self-position estimation from the true value of the relative position and a self-position estimation result calculated by the self-position estimation unit.

2. The map generation/self-position estimation device according to claim 1, wherein the data allocation unit allocates data of the measurement cycle to either the map generation data or the self-position estimation data for each measurement cycle of the external sensor, and calculates a true value of the relative position using a relative movement amount of the own vehicle acquired by a sensor.

3. The map generation/self-position estimation device according to claim 2, wherein
when allocating data acquired by the external sensor to the self-position estimation data, the data allocation unit sets a relative position attitude between newest map generation data and the self-position estimation data as the true value of the relative position, or
the data allocation unit selects the map generation data having a smallest difference in relative position attitude with respect to each of the self-position estimation data, and sets the relative position attitude between the self-position estimation data and the map generation data as the true value of the relative position.

4. The map generation/self-position estimation device according to claim 1, wherein
the external sensor includes a plurality of sensors, and
the data allocation unit allocates data measured by each external sensor to either the map generation data or the self-position estimation data, and calculates the true value of the relative position using an installation position attitude between each of the external sensors calculated by a prior calibration.

5. The map generation/self-position estimation device according to claim 4, wherein
the data allocation unit fixedly allocates data of each of the external sensors to either the map generation data or the self-position estimation data regardless of a measurement cycle of each of the external sensors,
the data allocation unit variably allocates data of each of the external sensors to either the map generation data or the self-position estimation data for each measurement cycle of each of the external sensors, or
the data allocation unit calculates the true value of the relative position using only data acquired by each of the external sensors while an own vehicle is stopped.

6. The map generation/self-position estimation device according to claim 1, wherein
the data allocation unit allocates data of the external sensor based on a maximum data capacity that can be processed by the map generation unit set in advance or a data capacity required by the map generation unit, or
the data allocation unit exclusively allocates the map generation data and the self-position estimation data.

7. The map generation/self-position estimation device according to claim 1, wherein
the data allocation unit and the map generation unit operate online, and
the self-position estimation unit estimates a travel position of the own vehicle on the generation map based on a generation map generated by the map generation unit and the self-position estimation data of past that is temporarily saved, or,
the data allocation unit prepares a plurality of sets of the map generation data, the self-position estimation data, and the true value of the relative position in which a data allocation method is changed,
the map generation unit generates the generation map for each of the plurality of pieces of map generation data,
by using a plurality of the generation maps and the self-position estimation data corresponding to the plurality of generation maps, the self-position estimation unit estimates a travel position of the own vehicle on each of the generation maps, and
the accuracy evaluation unit calculates a statistic or a distribution of an error in the self-position estimation from the error in the self-position estimation for each set of data, or,
the data allocation unit gives noise to the map generation data and the self-position estimation data, and
the accuracy evaluation unit calculates a relationship between a magnitude of the noise and the error in the self-position estimation.

8. The map generation/self-position estimation device according to claim 1, further comprising
a record unit that records the generation map as a record map based on the error in the self-position estimation calculated by the accuracy evaluation unit, wherein
the record unit records the generation map as the record map only when the error in the self-position estimation is smaller than a preset threshold.

9. The map generation/self-position estimation device according to claim 8, wherein the record unit records, as the record map, only a section of the generation map in which the error in the self-position estimation is smaller than a preset threshold.

10. The map generation/self-position estimation device according to claim 8, wherein
the data allocation unit prepares a plurality of sets of the map generation data, the self-position estimation data, and a true value of the relative position in which a data allocation method is varied,
the map generation unit generates the generation map for each of the plurality of pieces of map generation data,
the self-position estimation unit estimates a travel position of the own vehicle on each of the generation maps by using the plurality of generation maps and the self-position estimation data corresponding to the plurality of generation maps,
the accuracy evaluation unit calculates the error in the self-position estimation for data of each set, and
the record unit records, as the record map, the generation map generated in a set having a smallest mean, median, or maximum value of the error in the self-position estimation.

11. The map generation/self-position estimation device according to claim 10, wherein
the map generation unit generates a plurality of the generation maps by varying a map generation parameter,
the self-position estimation unit calculates a plurality of the self-position estimation results by varying a self-position estimation parameter for each of the plurality of generation maps,
the accuracy evaluation unit calculates a plurality of the self-position estimation errors, and
the record unit records, as the record map, the generation map generated in a set having a smallest mean, median, or maximum value of errors in the self-position estimation, the map generation parameter used for generation of the generation map, and the self-position estimation parameter used for calculation of the self-position estimation result.

12. The map generation/self-position estimation device according to claim 8, wherein
the record unit records the record map into a server connected to the map generation/self-position estimation device via a network, or
the record unit transmits information on a travel section of the own vehicle to the server when recording the record map into the server connected to the map generation/self-position estimation device via the network, and not recording the generation map as the record map based on the error in the self-position estimation.

13. The map generation/self-position estimation device according to claim 1, further comprising a sensor abnormality determination unit that determines an abnormality of the external sensor based on the error in the self-position estimation calculated by the accuracy evaluation unit.

14. The map generation/self-position estimation device according to claim 8, wherein
the record unit includes the error in the self-position estimation calculated by the accuracy evaluation unit into the record map,
when the own vehicle travels again in a section where the record map exists, the self-position estimation unit estimates a position attitude of the own vehicle on the record map from data of the external sensor and the record map, and
the map generation/self-position estimation device further includes a mode selection unit that calculates a current prediction error from a position attitude of the own vehicle on the record map estimated by the self-position estimation unit and the error in the self-position estimation included in the record map, and selects an operation mode of the map generation/self-position estimation device from a map generation mode and a position estimation mode based on the current prediction error.

15. The map generation/self-position estimation device according to claim 14, wherein the mode selection unit selects an operation mode allowed for an automatic driving/driving assistance system connected to the map generation/self-position estimation device based on the current prediction error.
